(19) United States
(12) Patent Application Publication
(10) Pub. No.: US 2007/0272674 A1
(43) Pub. Date: Nov. 29, 2007

(54) ABRASIVE BRUSH RECOVERY SYSTEM AND PROCESS

(75) Inventor: Siong Hong Koh, Singapore (SG)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/420,513

(22) Filed: May 26, 2006

(51) Int. Cl. F27B 5/14; F27D 11/00

(52) U.S. Cl. 219/390

(57) ABSTRACT

One embodiment of the disclosure is a method for changing a cutting ability of an abrasive device. The method includes abrading a portion of an abrasive device, thereby reducing a cutting ability of the abrasive device. Moreover, the method includes heating the abrasive device to fuse materials therein, thereby increasing a cutting ability of the abrasive device. Another embodiment of the disclosure includes a method for treating an abrasive brush having a plurality of bristles, each bristle having a distal tip; the method includes rotating the brush so that a plurality of bristle tips contact a hot plate. The disclosure also describes an apparatus for increasing a cutting ability of a used abrasive device, the apparatus comprising a heating element to fuse materials of the abrasive device.

### TECHNICAL FIELD

The present disclosure relates to a system and process for the recovery of abrasive brush cutting ability.

### BACKGROUND

Printed circuit boards (PCB's) are ubiquitous in manufactured products with electronic components. During the manufacture of PCB's, a copper layer is laminated to a composite insulating board (frequently epoxy-glass). Holes are then drilled in prescribed locations in the laminate. Prior to subsequent manufacturing steps, it is vital that vestigial burrs from the drilling step be removed and that the surface of the composite board is thoroughly cleaned. Rotary brushes are typically employed to perform this deburring step. Rotary brushes may be bristle brushes or nonwoven brushes having abrasive capabilities, for example.

The abrasive surfaces at an outside diameter (OD) of a rotary brush are typically used for abrading a work surface. Thus, portions of the OD generally become flattened by use. During a typical PCB manufacturing operation, PCB's of different widths are processed, leading to uneven wear across a brush. This can result in an undesirable undulating OD on the brush. A process called dressing can be used to remove a layer of material at the OD and thereby achieve a uniform OD across the brush. In one embodiment, dressing is accomplished online by bringing a diamond abrasive board in contact with a rotating brush to level off the undulating profile across the brush OD.

After this dressing operation, cutting performance of an abrasive brush generally drops due to the loose minerals and frayed resin that result from the dressing operation. In many cases, the brush can be conditioned to recover some of the abrasive or cutting abilities. There remains a need for a fast and efficient brush recovery system.

### SUMMARY

One embodiment of the disclosure is a method for changing a cutting ability of an abrasive device. The method includes abrading a portion of an abrasive device, thereby reducing a cutting ability of the abrasive device. Moreover, the method includes heating the abrasive device to fuse materials therein, thereby increasing a cutting ability of the abrasive device. Another embodiment of the disclosure includes a method for treating an abrasive brush having a plurality of bristles, each bristle having a distal tip; the method includes rotating the brush so that a plurality of bristle tips contact a hot plate. The disclosure also describes an apparatus for increasing a cutting ability of a used abrasive device, the apparatus comprising a heating element to fuse materials of the abrasive device.

### BRIEF DESCRIPTION OF DRAWINGS

FIG. 1 is a perspective view of a brush that is processed in one embodiment of the present disclosure.

FIG. 2a is an enlarged view of a section of brush bristle tips after dressing.

FIG. 2b is an enlarged view of the section of brush bristle tips of FIG. 2a after hot plate treatment.

FIG. 3 is a perspective view of a first embodiment of a hot plate treatment apparatus of the present disclosure.

FIG. 4 is a perspective view of a second embodiment of a hot plate treatment apparatus of the present disclosure.

FIG. 5 is an enlarged cross-sectional view along line 5-5 of FIG. 4 of a hot plate and heating elements in an exemplary embodiment, with a brush shown in phantom.

While the above-identified drawing figures set forth several exemplary embodiments of the disclosure, other embodiments are also contemplated. This disclosure presents illustrative embodiments of the present invention by way of representation and not limitation. Numerous other modifications and embodiments can be devised by those skilled in the art which fall within the scope and spirit of the principles of the present disclosure. The drawing figures are not drawn to scale.

Moreover, while embodiments, components, and examples are referred to by the designations “first,” “second,” “third,” etc., it is to be understood that these descriptions are bestowed for convenience of reference and do not imply an order of preference. The designations are presented merely to distinguish between different embodiments for purposes of clarity.

Unless otherwise indicated, all numbers expressing feature sizes, amounts, and physical properties used in the specification and claims are to be understood as being modified in all instances by the term “about.” Accordingly, unless indicated to the contrary, the numbers set forth are approximations that can vary depending upon the desired properties using the teachings disclosed herein.

### DETAILED DESCRIPTION

Abrasive devices such as rotary brushes are used to clean, abrade, and polish surfaces; to remove coatings; and to prepare surfaces for subsequent processing. In a case where a rotary brush is a bristle brush, the bristles of the brush may be oriented to extend radially or perpendicularly from a driven base structure. Brushes that have bristles that extend radially are frequently referred to as radial brushes. Brushes that have bristles that extend perpendicularly from a base are frequently referred to as right angle brushes. Non-bristle abrasive brushes include nonwoven brushes, for example.

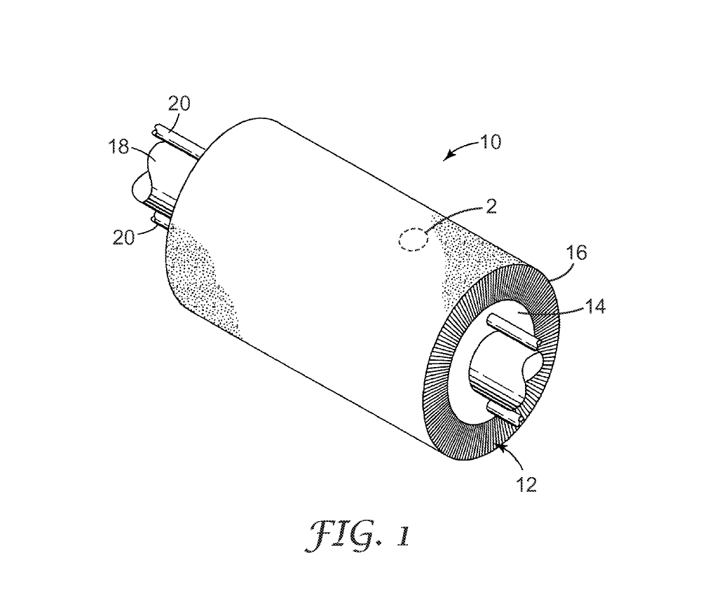

FIG. 1 is a perspective view of a brush that is processed in one embodiment of the present disclosure. A suitable abrasive brush is disclosed in commonly owned U.S. Patent Application Publication No. 2005/0153558, entitled “Molded abrasive brush and methods of using for manufacture of printed circuit boards,” hereby incorporated by reference. Abrasive brush 10 includes a plurality of bristles 12 that project outwardly from a core 14 of the brush. Bristles 12 have distal bristle tips 16, remote from core 14.

In one embodiment, multiple brush segments are assembled onto rotating shaft 18 and include a means for providing segment-to-segment engagement to reduce or eliminate rotation of adjacent brush segments relative to one another, such as locking rods 20. One suitable method for assembling and mounting brushes is disclosed in U.S. Pat. No. 5,327,601 (Nakayama et al.), which discusses making two halves of a brush assembly, and then clamping the two halves onto a driven shaft.

In one suitable application, brush 10 is used to refine the surface of a printed circuit board (PCB). During the manufacture of PCB's in one example, a copper layer is laminated to a composite insulating board (frequently, an epoxy-glass board). Holes are then drilled in prescribed locations in the laminate. Prior to subsequent manufacturing steps, it is vital that burrs from the drilling step be removed and that the surface of the composite board is thoroughly cleaned. Brush 10 is used in one example to abrade the PCB surface, thus imparting a surface finish to the PCB and cleaning the PCB surface.

A machine that can be used for PCB finishing or refining is a “PCB Scrubbing Machine,” available from Ishii Hyoki Machine Company of Japan. Such a machine has a 2.2 kW or 3.7 kW rated spindle motor. Both “2 head” and “4 head” machines are known and are common.

In a case where brush 10 is between 12 inches (30.5 cm) and 24 inches (61.0 cm) wide, typical pressures between the PCB surface and brush 10 are between 0 and 3 amperes; exemplary pressures are between 0.5 and 2 amperes. The PCB is fed through the PCB Scrubbing Machine at a speed of between 0.5 and 10 m/min, usually between 1 and 3 m/min. Brush 10 can be rotated at any suitable speed, preferably in the range of about 100 to 15,000 rpm, although higher or lower speeds can be used as desired. Typical rotation speeds for a PCB Scrubbing Machine are between 500 and 3000 rpm and in some cases between about 1500 and 2000 rpm for a brush 10 with a 6 inch (15.2 cm) diameter. It is understood that the relative speed between PCB surface and brush 10 will affect the surface finish obtained.

The usual surface finish or roughness desired on a PCB surface after “deburring” is about 0.05-3 micrometer Ra; an exemplary roughness is between 0.1 and 0.2 micrometer Ra. The usual surface finish desired after deburring and prior to dry film lamination is 0.05-0.2 micrometer Ra; an exemplary roughness is between 0.05 and 0.15 micrometer Ra.

Brush 10 will create a footprint, which is the length along the PCB surface where bristles 12 contact the surface. In this footprint area, the interference is the depth to which bristles 12 would have extended if the PCB surface was not present. These brush dynamics (the relationship between interference, footprint and pressure) affect the surface finish provided by brush 10.

The abrasive particles at bristle tips 16 are used for abrading the work surface. Thus, the tips 16 of bristles 12 generally become flattened by use. During a typical PCB manufacturing operation, PCB's of different widths are processed, leading to differential levels of bristle tip flattening across brush 10. This can result in an undesirable undulating outside diameter (OD) on brush 10. A process called dressing can be used to remove the ends from bristles 12 and thereby achieve uniform OD (Outside Diameter) across the brush 10. In one embodiment, dressing is accomplished online by bringing a diamond abrasive board in contact with rotating brush 10 to level off the undulating profile across the brush OD.

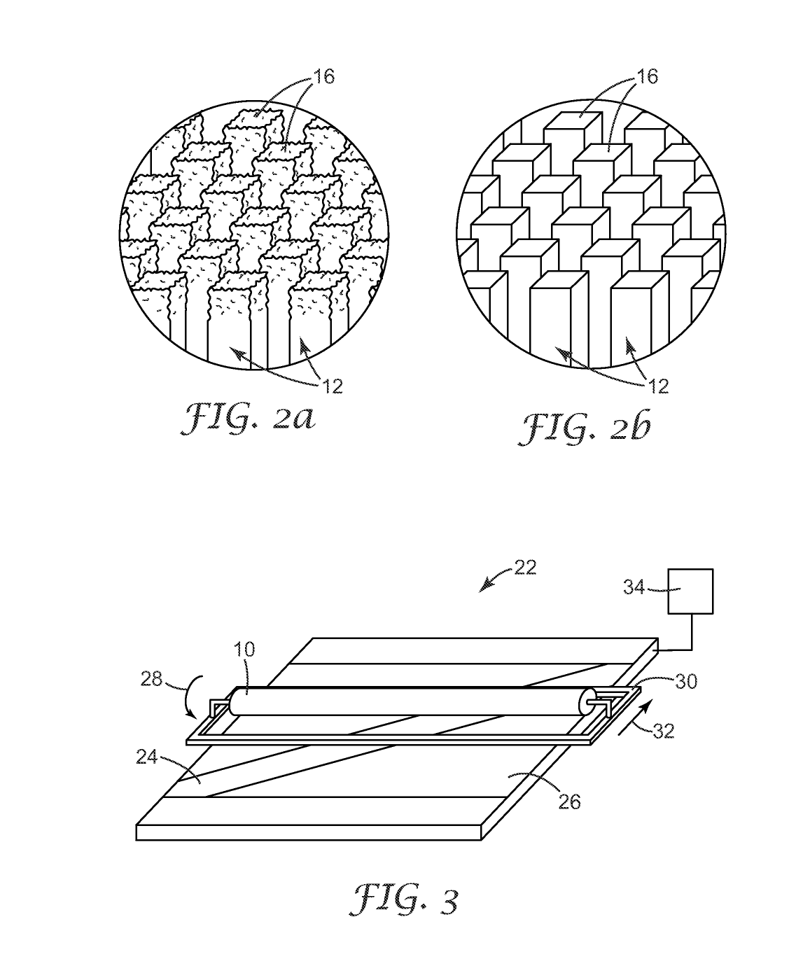

FIG. 2a is a magnified view of a section 2 of brush bristle tips 16 of FIG. 1 after dressing. Dressing typically involves abrading off the ends of bristles 16 to achieve a uniform OD across brush 10. Dressed bristle tips 16 may lose their cut performance after the diamond board dressing operation due to the presence of frayed resin and abrasive material at bristle tips 16.

In the state of the art, one method of recovering cut performance involves using the brush on non-production or “dummy” boards to condition the bristle tips 16. It typically takes close to 2 hours of dummy board operation (equivalent to passing through approximately 90 m² of printed circuit boards) to condition the bristle tips before attaining adequate cut performance for subsequent use.

A method of the present disclosure is directed to reducing the amount of time required to increase the cutting ability of a used abrasive device. An exemplary method changes a cutting ability of an abrasive device. The method comprises abrading a portion of an abrasive device, thereby reducing a cutting ability of the abrasive device; and heating the abrasive device to fuse materials therein, thereby increasing a cutting ability of the abrasive device. In an exemplary embodiment, bristle tips 16 are conditioned by contact with a heated element, such as an electrical hot plate. In one embodiment, a hot plate acts as a heat source to “fuse” the frayed and loose materials at the tips 16 in order to hold on to the abrasive particles more rigidly, thus, increasing subsequent cut performance.

FIG. 2b is an enlarged view of the section of brush bristle tips of FIG. 2a after hot plate treatment. In one example, a rotating brush 10 was contacted with a hot plate kept at 115 degree Celsius; only 6 minutes were required to recover cut performance of the brush 10 to approximately 50% of maximum cut performance after online diamond board dressing (where cut performance of the brush 10 immediately after online diamond board dressing is considered to be 0% of the initial cut performance).

FIG. 3 is a perspective view of one embodiment of a hot plate treatment apparatus of the present disclosure. In this embodiment, an electrical hot-plate is used to recover the cut performance of an abrasive bristle brush. One suitable brush for use in the disclosed process is the “FH Radial Bristle Brush” available from 3M Company of St. Paul, Minn., which is designed for printed circuit board deburring/cleaning applications.

An exemplary embodiment of hot plate treatment system 22 includes hot plate 24 embedded in board 26. In one embodiment, hot plate 24 is made of aluminum and board 26 is made of a thermally insulating material such as fiberglass. The insulating material of board 26 prevents heat loss to the environment during the hot plate cut recovery operation. In one embodiment, hot plate 24 is a strip that is about 60 mm wide and board 26 is 610 mm×300 mm. In one embodiment, brush 10 is a FH 400 Brush from 3M Company and is 610 mm wide. As shown in FIG. 3, brush 10, which rotates in direction 28, is mounted on conveyor 30, which travels in direction 32. The operation is controlled by controller 34. It should be understood that specific configurations and movement directions can be altered in other embodiments. Moreover, any conveyor mechanism may be used to support, move and/or rotate brush 10 relative to hot plate 24.

In an exemplary embodiment, hot plate 24 consists of four 800-watt filaments, connected in parallel, inserted beneath an aluminum plate. A substantial amount of air current is generated by rotating brush 10. Such air movement can undesirably cool the hot plate 24. Hence, to minimize heat loss during the hot plate operation and to maintain relatively high unit pressure between the brush 10 and the hot plate 24, the hot plate 24 in an exemplary embodiment has a narrow width (60 mm) and is inclined at a 60 degree angle. In this example, the hot plate 24 was also entrenched within a fiber glass insulator board 26.

During the hot plate operation in one embodiment, only a small section of the brush width is in contact with the hot plate 24 at any interval. In one embodiment, an interval of contact is approximately 110 mm wide; thus, six intervals are used to heat treat the whole brush width (610 mm). The conveyor 30 is activated intermittently at 3-minute intervals to bring the 6 different sections of brush 10 into contact with the hot aluminum plate 24. Thus, a total duration of 18 minutes is used to bring all the bristle tips 16 into contact with the hot plate 24.

TABLE 1 summarizes the findings of several trials, using both aluminum and stainless steel hot plate materials. In a first evaluation, hot plate treatment of a diamond-board dressed FH 240 Brush (85 mm wide) from 3M Company was accomplished using either a 1 mm aluminum (Al) hot plate or a 1 mm stainless steel (SS) hot plate. Each hot plate was manually pressed against the rotating brush (1800 rpm) for a fixed duration. After hot plate treatment, brush 10 was used in a flat part deburring AMADA machine (IBT-610 EXP), available from Amada American, Inc., Buena Park, Calif. for cut performance tests. The cut tests used a conveyor speed of 2 m/min and a pressure of 1.0 amp/150 mm. The cut tests were performed on 220 mm×150 mm×1 mm PCB test substrates, using 2 passes. The cut performance tests measure the substrate removal performance of the tested brushes.

TABLE 1
Cut Performance Chart

| | Duration | Hot Plate | Temp | Cut | % of Initial |
|---|---|---|---|---|---|
| Conditions | (min) | Material | (° C.) | (mg) | Cut Rate |
| original bristle | n/a | n/a | n/a | 50.0 | n/a |
| (no dressing) | | | | | |
| after diamond | 1.0 | n/a | n/a | 0.0 | 0.0 |
| board dressing | | | | | |
| after Al hot | 2.0 | Aluminum | 70 | 29.0 | 58.0 |
| plate, trial A | | | | | |
| after Al hot | 2.0 | Aluminum | 70 | 20.0 | 40.0 |
| plate, trial B | | | | | |
| after Al hot | 2.0 | Aluminum | 70 | 22.0 | 44.0 |
| plate, trial C | | | | | |
| after Al hot | 2.0 | Aluminum | 80 | 27.0 | 54.0 |
| plate, trial D | | | | | |
| after SS hot | 2.0 | Stainless | 80 | 18.0 | 36.0 |
| plate, trial E | | Steel | | | |
| after SS hot | 4.0 | Stainless | 80 | 22.0 | 44.0 |
| plate, trial F | | Steel | | | |

Based on these trials, there is reason to believe that aluminum hot plates are more efficient in increasing the cut performance of brush 10 after dressing than stainless steel hot plates. Hot plate treatment appears to fuse the excess bristle tip resin and other particles at the bristle tips 16, thereby setting the resin for holding the abrasive minerals better. The result of the hot plate treatment process appears to be an increase in cut performance.

In a second evaluation, the hot plate treatment of a diamond-board dressed FH 400 Brush (610 mm wide) from 3M Company was accomplished in six 110 mm wide intervals, at a pressure of 1.0 amp/110 mm interval. After hot plate treatment, brush 10 was used in a flat part deburring AMADA machine (IBT-610 EXP) for cut performance tests. The cut tests used a conveyor speed of 2 m/min and a pressure of 1.0 amp/150 mm. The cut tests were performed on two 220 mm×150 mm×1 mm PCB test substrates, using 2 passes on each substrate. The results are shown in TABLE 2.

TABLE 2
Original bristle brush cutting

| | | substrate | substrate | |
|---|---|---|---|---|
| Pressure (amp) | substrate | before (g) | after (g) | cut (g) |
| 1.0 | 1 | 72.415 | 72.298 | 0.117 |
| 1.0 | 2 | 72.298 | 72.176 | 0.122 |
| | | | | 0.120 average |

After a period of use, brush 10 was diamond board dressed in four intervals, at a duration of 0.5 min/interval, for a total of 2 minutes. The results are shown in TABLE 3.

TABLE 3
Bristle brush after diamond board dressing

| Pressure | | substrate | substrate | | % of |
|---|---|---|---|---|---|
| (amp) | substrate | before (g) | after (g) | cut (g) | original |
| 1.0 | 1 | 70.704 | 70.702 | 0.002 | |
| 1.0 | 2 | 70.702 | 70.700 | 0.002 | |
| | | | | 0.002 | 1.67 |
| | | | | average | |

Brush 10 then underwent hot plate treatment at a temperature of 115° C., in six 110 mm wide intervals. The hot plate treatment was accomplished at a pressure of 1.0 amp/110 mm interval and a duration of 3 minutes per interval, for a total of 18 minutes. The results are shown in TABLE 4.

TABLE 4
Bristle brush after first hot plate treatment

| Pressure | | substrate | substrate | | % of |
|---|---|---|---|---|---|
| (amp) | substrate | before (g) | after (g) | cut (g) | original |
| 1.0 | 1 | 72.623 | 72.581 | 0.042 | |
| 1.0 | 2 | 72.138 | 72.102 | 0.036 | |
| | | | | 0.039 | 32.64 |
| | | | | average | |

Brush 10 then underwent additional runs of hot plate treatment at a temperature of 115° C., in six 110 mm wide intervals. Each additional hot plate treatment was accomplished at a pressure of 1.0 amp/110 mm interval and a duration of 3 minutes per interval, for a total of 18 minutes per additional run. The results are shown in TABLES 5 and 6.

TABLE 5
Bristle brush after second hot plate treatment

| Pressure | | substrate | substrate | | % of |
|---|---|---|---|---|---|
| (amp) | substrate | before (g) | after (g) | cut (g) | original |
| 1.0 | 1 | 73.101 | 73.044 | 0.057 | |
| 1.0 | 2 | 72.195 | 72.152 | 0.043 | |
| | | | | 0.050 | 41.84 |
| | | | | average | |

TABLE 6
Bristle brush after third hot plate treatment

| Pressure | | substrate | substrate | | % of |
|---|---|---|---|---|---|
| (amp) | substrate | before (g) | after (g) | cut (g) | original |
| 1.0 | 1 | 72.152 | 72.092 | 0.060 | |
| 1.0 | 2 | 72.052 | 72.006 | 0.046 | |
| | | | | 0.053 | 44.35 |
| | | | | average | |

As shown in TABLES 4-6, cut performance of FH Brush increases after additional runs of hot plate treatment (3 min. per interval at 115° C.). From the results in Tables 4 and 5, two hot plate treatments, for a total treatment time of 36 minutes, were sufficient to accelerate FH Bristle Brush (full size) cut performance from near zero cut performance to approximately 40% of initial cut performance, using an AMADA IBT-610 EXP deburring machine.

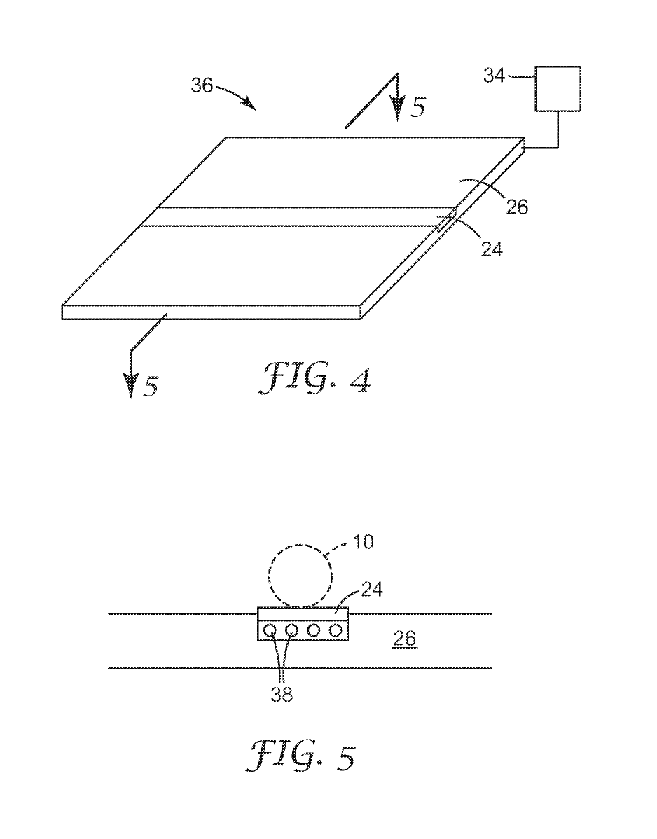

In another exemplary embodiment, hot plate 24 is configured to contact the entire length of the brush at once, rather than in multiple intervals. FIG. 4 is a perspective view of a second embodiment of a hot plate treatment apparatus 36 of the present disclosure. The illustrated embodiment is an example of a horizontal hot plate 24 (zero angle) positioned on board 26. Conveyor 30 and brush 10 are not shown for clarity of illustration. In the use of this embodiment, a brush 10 would contact hot plate 24 along the entire length of brush 10 at once. FIG. 5 is an enlarged cross-sectional view along line 5-5 of FIG. 4 of a hot plate 24 and heating elements 38 embedded in board 26 in an exemplary embodiment, with a brush 10 shown in phantom. In one example using hot plate treatment apparatus 36, contacting the brush 10 to the hot plate 24, heated to 115° C., for about 6 minutes results in cut performance of about 45%. Thus, hot plate treatment leads to a significant reduction in cut recovery time, as compared to the state of the art method of cut recovery, which typically takes about 2 hours of dummy board processing to condition the brush tips before adequate cutting ability is realized.

Based on experience in PCB deburring manufacturing processes, cut performance in the range of 40-50% of initial cut performance is generally sufficient to produce a uniform finish for production. Thus, the conditions of hot plate treatment may be modified according to the teachings of the present disclosure to attain the desired level of cut performance.

It was noticed in other evaluations that both higher temperature and duration of contact have positive effects in accelerating cut performance recovery of brush 10. There was also an observation that temperature has a larger influence on the cut recovery acceleration process. In an exemplary embodiment, hot plate 24 is heated to greater than about 100° C. In some embodiments, hot plate 24 is heated to a temperature between about 115° C. and 200° C. In the trials, a temperature of 115° C. was chosen because any higher temperatures may melt or otherwise damage the conveyor belt of the deburring machine (AMADA IBT-610 EXP). Thus, it is possible to achieve even shorter cut recovery times for another machine with a conveyor belt/roller that is resistant to higher temperatures.

In a fourth evaluation, the effect of hot plate cut recovery was also tested on a PCB brush of nonwoven construction. A diamond-board dressed nonwoven brush, available from Sumitomo 3M, Japan, under the designation HD-7S-SFN, was hot-plate treated in six 110 mm wide intervals, at a pressure of 1.0 amp/110 mm interval. After hot plate treatment, brush 10 was used in a flat part deburring AMADA machine (IBT-610 EXP) for cut performance tests. The cut tests used a conveyor speed of 2 m/min and a pressure of 1.0 amp/150 mm. The cut tests were performed on two 220 mm×150 mm×1 mm PCB test substrates, using 2 passes on each substrate. The results are shown in TABLE 7.

TABLE 7
Original nonwoven brush cutting

| | | substrate | substrate | |
|---|---|---|---|---|
| Pressure (amp) | substrate | before (g) | after (g) | cut (g) |
| 1.0 | 1 | 72.333 | 72.200 | 0.133 |
| 1.0 | 2 | 72.454 | 72.330 | 0.124 |
| | | | | 0.128 average |

After a period of use, the nonwoven brush was diamond board dressed in four intervals, at a duration of 0.25 min/interval, for a total of 1 minute. The results are shown in TABLE 8.

TABLE 8
Nonwoven brush after diamond board dressing

| Pressure | | substrate | substrate | | % of |
|---|---|---|---|---|---|
| (amp) | substrate | before (g) | after (g) | cut (g) | original |
| 1.0 | 1 | 70.200 | 70.169 | 0.031 | |
| 1.0 | 2 | 70.169 | 70.140 | 0.029 | |
| | | | | 0.030 | 23.35 |
| | | | | average | |

The nonwoven brush then underwent hot plate treatment at a temperature of 115° C., in six 110 mm wide intervals. The hot plate treatment was accomplished at a pressure of 1.0 amp/110 mm interval and a duration of 3 minutes per interval, for a total of 18 minutes. The results are shown in TABLE 9.

TABLE 9
Nonwoven brush after hot plate treatment

| Pressure | | substrate | substrate | | % of |
|---|---|---|---|---|---|
| (amp) | substrate | before (g) | after (g) | cut (g) | original |
| 1.0 | 1 | 72.146 | 72.042 | 0.104 | |
| 1.0 | 2 | 72.042 | 71.933 | 0.109 | |
| | | | | 0.106 | 89.12 |
| | | | | average | |

For comparison, in a fifth evaluation, the effect of dummy board operation on a nonwoven brush was exemplified. A diamond-board dressed nonwoven brush, available from Sumitomo 3M, Japan, under the designation HD-7S-SFN, was hot-plate treated in six 110 mm wide intervals, at a pressure of 1.0 amp/110 mm interval. After hot plate treatment, brush 10 was used in a flat part deburring AMADA machine (IBT-610 EXP) for cut performance tests. The cut tests used a conveyor speed of 2 m/min and a pressure of 1.0 amp/150 mm. The cut tests were performed on two 220 mm×150 mm×1 mm PCB test substrates, using 2 passes on each substrate. The original brush had the properties described above in TABLE 7. After a period of use, the nonwoven brush was diamond board dressed in four intervals, at a duration of 0.25 min/interval, for a total of 1 minute. The results are shown in TABLE 10.

TABLE 10
Nonwoven brush after diamond board dressing

| Pressure | | substrate | substrate | | % of |
|---|---|---|---|---|---|
| (amp) | substrate | before (g) | after (g) | cut (g) | original |
| 1.0 | 1 | 70.315 | 70.280 | 0.035 | |
| 1.0 | 2 | 70.280 | 70.249 | 0.031 | |
| | | | | 0.033 | 25.68 |
| | | | | average | |

The nonwoven brush then underwent dummy board operation for a duration of 45 minutes at a pressure of 1.0 amp/110 mm. The results are shown in TABLE 11.

TABLE 11
Nonwoven brush after dummy board operation

| Pressure | | substrate | substrate | | % of |
|---|---|---|---|---|---|
| (amp) | substrate | before (g) | after (g) | cut (g) | original |
| 1.0 | 1 | 72.986 | 72.900 | 0.086 | |
| 1.0 | 2 | 72.952 | 71.872 | 0.080 | |
| | | | | 0.083 | 64.59 |
| | | | | average | |

From the results in TABLE 9, it is apparent that hot plate treatment decreases the time needed to recover the cut performance of the nonwoven construction brush. It takes only 18 minutes of hot plate contact with a rotating nonwoven brush to bring cut recovery to over 89%, as compared to about 65% cut recovery achieved by 45 minutes of dummy board operation. Hence, hot plate cut recovery has a clear advantages in time savings over current industry wide cut recovery methods using dummy board processing for abrasive materials including but not limited to bristle and nonwoven brushes.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A method for changing a cutting ability of an abrasive device, the method comprising:
abrading a portion of an abrasive device, thereby reducing a cutting ability of the abrasive device; and
heating the abrasive device after abrading the abrasive device to fuse materials therein, thereby increasing a cutting ability of the abrasive device.

2. The method of claim 1 wherein the abrasive device comprises an abrasive brush having a plurality of bristles, each bristle having a distal tip, and the step of heating the abrasive device comprises heating a plurality of bristle tips.

3. The method of claim 2 wherein the step of heating the abrasive device comprises contacting the plurality of bristle tips with a heated element.

4. The method of claim 3 further comprising cutting off a plurality of bristle ends before contacting the remaining bristle tips with the heated element.

5. The method of claim 3 wherein the heated element comprises a hot plate.

6. The method of claim 5 further comprising heating the hot plate to a temperature greater than 100° C.

7. The method of claim 5 further comprising rotating the abrasive device while heating the abrasive device.

8. The method of claim 1 wherein a cutting ability of the abrasive device after heating is greater than about 40% of an original cutting ability of the device.

9. An apparatus for increasing a cutting ability of a used abrasive device, the apparatus comprising a heating element to fuse materials of the abrasive device.

10. The apparatus of claim 9 further comprising a rotary shaft on which the abrasive device is mounted.

11. The apparatus of claim 10 wherein the abrasive device is a brush.

12. The apparatus of claim 11 wherein the abrasive device is a bristle brush.

13. The apparatus of claim 11 wherein the abrasive device is a nonwoven brush.

14. The apparatus of claim 9 wherein the heating element comprises a hot plate.

15. The apparatus of claim 14 wherein the hot plate comprises aluminum.

16. The apparatus of claim 14 wherein the hot plate is disposed on a thermally insulating board.

17. The apparatus of claim 6 wherein the board comprises fiberglass.

18. A method for treating an abrasive brush having a plurality of bristles, each bristle having a distal tip, the method comprising rotating the brush so that a plurality of bristle tips contact a hot plate.

19. The method of claim 18 further comprising heating the hot plate to a temperature greater than 100° C.

20. The method of claim 1 wherein the abrasive device comprises abrasive particles.

21. The method of claim 2 wherein the plurality of distal tips are not melted together.

22. The method of claim 2 wherein the plurality of bristles comprise abrasive particles.
